(19) United States
(12) Patent Application Publication
(10) Pub. No.: US 2026/0252021 A1
(43) Pub. Date: Aug. 27, 2026

(54) IMAGE FORMING APPARATUS

(71) Applicant: CANON KABUSHIKI KAISHA, Tokyo (JP)

(72) Inventors: YUKI TANAKA, Shizuoka (JP); MASAKI SHIMOMURA, Shizuoka (JP); AKIRA MATSUSHIMA, Shizuoka (JP)

(21) Appl. No.: 19/443,178

(22) Filed: Jan. 8, 2026

(30) Foreign Application Priority Data
Feb. 21, 2025 (JP) 2025-027417

(51) Int. Cl. G03G 15/00; G03G 15/16; G03G 15/01

(52) U.S. Cl. CPC G03G 15/6558; G03G 15/1615; G03G 15/6511; G03G 15/0131; G03G 15/0189

(57) ABSTRACT

An image forming apparatus includes a feeding member to feed a recording material placed on a feeding portion from the feeding portion toward a transfer portion and a sheet-like charge eliminating cloth to eliminate charge of the recording material on a downstream of a conveyance portion and on an upstream of the transfer portion in a conveyance direction of the recording material. The charge eliminating cloth is disposed so as to oppose a surface of the recording material being conveyed by both the conveyance portion and the transfer portion in a non-contact manner. A supporting member is provided with a supporting surface to support the charge eliminating cloth. An angle formed by a normal line of the supporting surface and a direction of gravity is 45 degrees or more and less than 90 degrees.

### BACKGROUND

### Field of the Technology

The present invention relates to an image forming apparatus such as a printer, a copy machine and a facsimile machine or a multifunction machine having a plurality of functions of these functions using an electrophotographic type, an electrostatic recording type or the like.

### Description of the Related Art

In an image forming apparatus such as a printer of an electrophotographic type, a toner image formed on an image bearing member such as a photosensitive drum and an intermediary transfer belt is transferred to a recording material in a transfer portion. As the recording material, a sheet such as a plain paper is often used.

To such an image forming apparatus, in order to convey the sheet to the transfer portion, a sheet feeding member which sends out the sheet from a sheet feeding portion, on which the sheet is placed, a registration roller pair which adjusts a timing at which the sheet sent out from the sheet feeding portion enters the transfer portion, etc. are provided.

The sheet is charged by friction with the sheet feeding member and the registration roller pair. When the sheet is conveyed to the transfer portion in the charged state, it may cause that the toner image on the image bearing member is not transferred to the sheet, and/or the toner image is scattered.

To this, in Japanese Patent Application Laid-Open No. 2013-50600, a configuration in which an electric charge eliminating member is disposed in a non-contact manner with respect to a peripheral surface of a registration roller is proposed. In the configuration described in Japanese Patent Application Laid-Open No. 2013-50600, by suppressing that the registration roller is charged, it is intended to suppress that electric charge accumulated on the registration roller is moved to the sheet.

### SUMMARY

The object described above is achieved by an image forming apparatus according to the present invention. In summary, according to an aspect of the present invention, there is provided an image forming apparatus comprising: an image bearing member configured to bear a toner image; a transfer member configured to form a transfer portion to transfer the toner image from the image bearing member to a recording material by being in contact with the image bearing member and to convey the recording material in the transfer portion; a feeding portion on which the recording material is placed; a feeding member configured to feed the recording material placed on the feeding portion from the feeding portion toward the transfer portion; conveyance member configured to form a conveyance portion to convey the recording material fed from the feeding portion and to upwardly convey the recording material toward the transfer portion; a sheet-like charge eliminating cloth configured to eliminate charge of the recording material at a position downstream of the conveyance portion and upstream of the transfer portion in a conveyance direction of the recording material, the charge eliminating cloth being disposed so as to oppose a surface of the recording material being conveyed by both the conveyance portion and the transfer portion in a non-contact manner; and a supporting member provided with a supporting surface to support the charge eliminating cloth, wherein an angle formed by a normal line of the supporting surface and a direction of gravity is 45 degrees or more and less than 90 degrees.

Further features of the present invention will become apparent from the following description of exemplary embodiments with reference to the attached drawings.

### BRIEF DESCRIPTION OF THE DRAWINGS

FIG. 1 is a cross-sectional view illustrating an outline configuration of an image forming apparatus.

FIG. 2 is a schematic cross-sectional view illustrating a configuration around a registration roller and a secondary transfer portion.

FIGS. 3A, part (a) and (b), includes schematic cross-sectional views for describing an effect of a charge eliminating cloth.

FIGS. 3B, part (c) and part (d), includes schematic cross-sectional views for describing the effect of the charge eliminating cloth.

FIGS. 4, part (a) and part (b), includes views showing results of experiments which investigate effect by a distance between a sheet and the charge eliminating cloth and a difference in an area of a surface of the charge eliminating cloth opposing the sheet.

FIGS. 5, part (a) and part (b), includes views showing results of measuring a charge amount of the sheet.

FIGS. 6, part (a) and part (b), includes schematic cross-sectional views for describing a paper dust contamination suppressing effect.

FIG. 7 is a view showing results of experiments which investigate effect by a difference in a disposed angle of the charge eliminating cloth.

FIG. 8 is a view showing results of experiments which investigate effect by a difference in a potential of the charge eliminating cloth.

FIG. 9 is a schematic cross-sectional view illustrating a configuration around a registration roller and a secondary transfer portion in another Embodiment.

### DESCRIPTION OF THE EMBODIMENTS

Hereinafter, an image forming apparatus according to the present invention will be described in more detail according to the drawings.

### Embodiment 1

### Overall configuration of an image forming apparatus

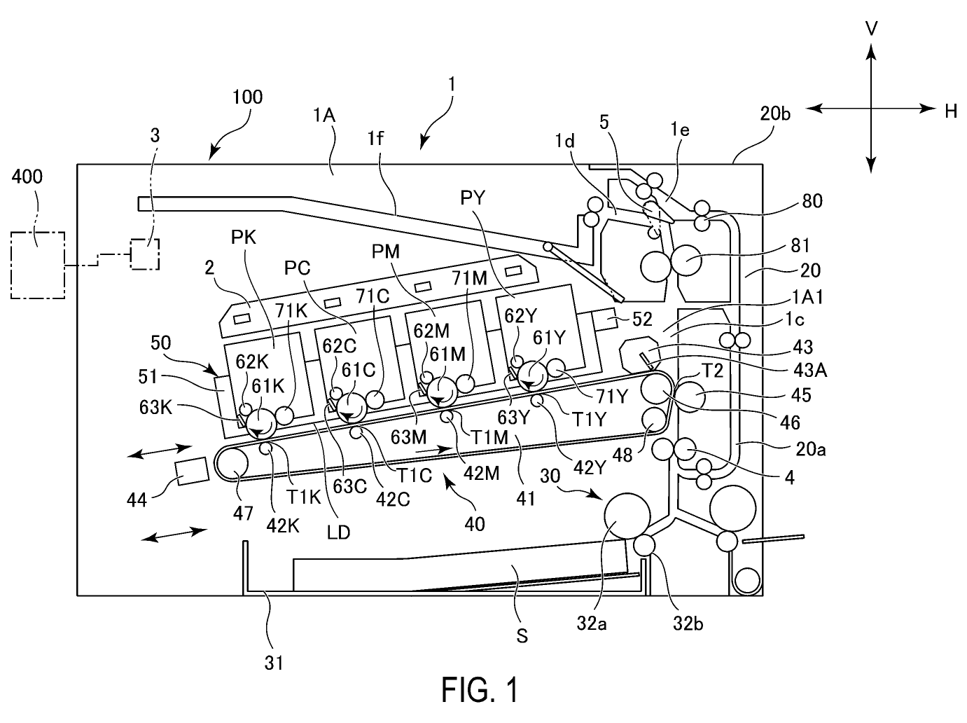

Using FIG. 1, an overall configuration of an image forming apparatus in the present Embodiment will be described. FIG. 1 is a cross-sectional view illustrating the overall configuration of the image forming apparatus in the present Embodiment. The image forming apparatus in the present Embodiment is a color laser beam printer 1 of tandem type employing an intermediary transfer type, which is capable of forming a full-color image on a sheet S, which is a recording material (recording medium, transfer material, sheet) having a sheet shape, using an electrophotographic type.

Incidentally, it will be described that the printer 1 is assumed to be used with installed on a horizontal plane. Disposition, orientation, etc. of each member in the printer 1, which will be described hereinafter, are disposition and orientation in a case in which the printer 1 is installed on the horizontal plane. A direction of an arrow V and a direction of an arrow H in FIG. 1 indicates a direction of gravity (vertical direction) and a horizontal direction in the case, respectively. In addition, with respect to the printer 1 and elements thereof, an up and down direction refers to up and down in the direction of gravity, however, it does not mean only directly above and directly below, but includes an upper side and a lower side than a horizontal plane which passes through a position or an element of interest. In addition, it can be said that the printer 1 often forms an image on a paper (sheet) as the recording material, however, the printer 1 is one which may form an image also on a recording material which is composed of material other than paper, such as a plastic sheet and a synthetic sheet, or material containing material other than paper.

The printer 1 includes an apparatus main assembly (housing) 1A, a scanner (exposure device) 2, a control portion 3 and a door (opening/closing member) 20, which is openable and closable to the apparatus main body 1A. In addition, the printer 1 includes a sheet feeding portion 30 as a feeding means, an intermediary transfer unit 40, a tray unit (moving unit, supporting unit) 50 and a fixing device 80. A portion including the apparatus main body 1A and the door 20 may also be referred to as a main frame 100. The main frame 100 includes an exterior portion of the printer 1. The apparatus main body 1A accommodates the scanner 2, the control portion 3, the sheet feeding portion 30, the intermediary transfer unit 40, the tray unit 50 and the fixing device 80.

The sheet feeding portion 30 includes a stacking tray 31 as a feeding portion (accommodating mechanism) on which the sheet S is placed, a pick roller (feeding member) 32a and a separating roller (separating member) 32b. The stacking tray 31 may be pulled out in a direction to the door 20 (right side in FIG. 1) so that the sheet S can be supplied.

The tray unit 50 includes a tray (cartridge supporting member, drawer) 51 and cartridges PY, PM, PC and PK. The tray 51 includes a tray handle 52. The cartridges PY, PM, PC and PK are dismountably attached to the tray 51. In other words, the cartridges PY, PM, PC and PK are mountable to and dismountable from the tray 51. The cartridges PY, PM, PC and PK are mountable to and dismountable from the tray 51 independently of other cartridges, respectively. The cartridges PY, PM, PC and PK accommodate toner (developer) of yellow (Y), magenta (M), cyan (C) and black (K), respectively. Configurations of the cartridges PY, PM, PC and PK are substantially the same except that colors of the toner, which are accommodated therein respectively, are different.

Incidentally, in the printer 1, elements having the same or corresponding functions or configurations, which are provided for each color of yellow, magenta, cyan and black, may be described collectively by omitting the Y, M, C and K at ends of the reference numerals, which indicate that an element is for either one of the colors. It can be said that the tray unit 50 includes a plurality of the cartridges P and the tray 51, to which the plurality of the cartridges P are dismountably attached.

In the present Embodiment, the tray unit 50 includes a plurality of photosensitive drums 61, a plurality of charging rollers (charging members) 62, a plurality of developing rollers (developer bearing members) 71 and a plurality of cleaning blades (cleaning members) 63. The photosensitive drum 61 is, as a first image bearing member which bears a toner image, a rotatable photosensitive member (electrophotographic photosensitive member) having a drum shape (cylindrical shape). Specifically, the tray unit 50 includes four of the photosensitive drums 61Y, 61M, 61C and 61K, four of the charging rollers 62Y, 62M, 62C and 62K, four of the developing rollers 71Y, 71M, 71C and 71K and four of the cleaning blades 63Y, 63M, 63C and 63K. In the tray unit 50, a portion which forms an image of yellow (Y) is referred to as a yellow station (first station). Similarly, a portion which forms an image of magenta (M) is referred to as a magenta station (second station), a portion which forms an image of cyan (C) is referred to as a cyan station (third station), and a portion which forms an image of black (K) is referred to as a black station (fourth station). These four stations are disposed side by side in this order in a moving direction of an image transfer surface of an intermediary transfer belt 41, which will be described below. The cartridge PY is mounted to the yellow station. The cartridge PM is mounted to the magenta station. The cartridge PC is mounted to the cyan station. The cartridge PK is mounted to the black station. In each station, the photosensitive drum 61, the charging roller 62, the developing roller 71 and the cleaning blade 63 may be provided to either the cartridge P or the tray 51. In the present Embodiment, the cartridge P includes the photosensitive drum 61, the charging roller 62, the developing roller 71 and the cleaning blade 63. The photosensitive drum 61 is rotated, by driving force from a driving source (not shown) being transmitted thereto, in a clockwise direction in FIG. 1.

The intermediary transfer unit 40 includes the intermediary transfer belt 41, a primary transfer roller (primary transfer member) 42, a belt cleaning portion 43 and a plurality of stretching rollers 46, 47 and 48. The intermediary transfer belt 41 is, as a second image bearing member which bears the toner image, an intermediary transfer member constituted by an endless belt. In the present Embodiment, the intermediary transfer unit 40 includes, as the plurality of stretching rollers, a driving roller 46, a tension roller 47 and an auxiliary roller 48. The driving roller 46 drives the intermediary transfer belt 41. The tension roller 47 applies tension to the intermediary transfer belt 41. The auxiliary roller 48 forms a surface of the intermediary transfer belt 41 entering a secondary transfer portion T2, which will be described below. On an inner peripheral surface side of the intermediary transfer belt 41, at positions opposing the respective photosensitive drums 61Y, 61M, 61C and 61K, the respective primary transfer rollers 42Y, 42M, 42C and 42K are disposed. The driving roller 46 is rotated by driving force from a driving source (not shown) being transmitted thereto. The intermediary transfer belt 41 is rotated (circularly moved), by driving force being transmitted from the driving roller 46 thereto, in a counterclockwise direction in FIG. 1. The stretching rollers other than the driving roller 46 and the respective primary transfer rollers 42 are rotated driven by the rotation of the intermediary transfer belt 41.

To the printer 1, an optical sensor 44 for detecting the toner image transferred to the intermediary transfer belt 41 is provided. In the present Embodiment, the intermediary transfer belt 41 is disposed below the photosensitive drum 61. The intermediary transfer belt 41 is capable of being in contact with the photosensitive drum 61. The intermediary transfer belt 41 forms a primary transfer portion T1, by being in contact with the photosensitive drum 61, between the photosensitive drum 61 and the intermediary transfer belt 41. A contact portion between the photosensitive drum 61 and the intermediary transfer belt 41 is the primary transfer portion (primary transfer nip) T1. In addition, the printer 1 includes, on an outer peripheral surface side of the intermediary transfer belt 41, at a position opposing the driving roller 46, a secondary transfer roller (secondary transfer member) 45. The driving roller 46 also functions as a secondary transfer opposite roller. The secondary transfer roller 45 is in contact with the driving roller 46 via the intermediary transfer belt 41, and forms the secondary transfer portion T2 between the intermediary transfer belt 41 and the secondary transfer roller 45. A contact portion between the intermediary transfer belt 41 and the secondary transfer roller 45 is the secondary transfer portion (secondary transfer nip) T2. In the present Embodiment, the secondary transfer roller 45 is rotated driven by the rotation of the intermediary transfer belt 41. However, the printer 1 may be configured so that the secondary transfer roller 45 is rotated by a driving source. A rotational axis direction of the primary transfer roller 42, a rotational axis direction of the driving roller 46, a rotational axis direction of the tension roller 47, a rotational axis direction of the auxiliary roller 48 and a rotational axis direction of the secondary transfer roller 45 are approximately parallel to each other. For a purpose of suppressing a height of the apparatus main body 1A, etc., the intermediary transfer unit 40 and the secondary transfer roller 45 are disposed so that, after the sheet S passes through a registration roller pair 4, which will be described below, until the sheet S enters the secondary transfer portion T2, a conveyance path of the sheet S becomes approximately vertical. Incidentally, “the conveyance path of the sheet S is approximately vertical” also includes a case in which the path is deviated by about 30 degrees or less with respect to the direction of gravity, and typically also includes a case in which the path is deviated by about 15 degrees or less with respect to the direction of gravity.

In addition, the printer 1 includes the registration roller pair 4 as a conveyance member, which is disposed on a downstream side of the sheet feeding portion 30 and on an upstream side of the secondary transfer portion T2 in a conveyance direction of the sheet S.

In addition, the fixing device 80 is disposed on the downstream side of the secondary transfer portion T2 in the conveyance direction of the sheet S. The fixing device 80 includes a fixing portion 81 and a flapper 5. Upon an image forming operation to the sheet S being performed, the fixing device 80 is at a use position. The fixing device 80 is accommodated, in a state of being at the use position, in an inner portion (inside) of the apparatus main body 1A. In addition, the fixing device 80 is configured, in the state of being at the use position, so as to heat the sheet S. In the present Embodiment, the fixing portion 81 includes a heating portion (heating roller) provided with a heater and a pressing portion (pressing roller) which presses the sheet S between the heating portion and itself.

### Image forming operation

Using FIG. 1, the image forming operation of the printer 1 will be described. The control portion 3 of the printer 1 starts, based on an image signal received from an external host device 400, the image forming operation to the sheet S. The external host device 400 is, for example, a personal computer, an image reader and a facsimile.

Upon the image formation to the sheet S being performed, the fixing device 80 is positioned at the use position, and the tray unit 50 is positioned at a first inside position, and the intermediary transfer unit 40 is positioned at a second inside position, and the door 20 is positioned at a closed position. In a state in which the intermediary transfer unit 40 is at the second inside position, the intermediary transfer belt 41 is capable of being in contact with the photosensitive drum 61. At this time, the tray unit 50 is positioned above the intermediary transfer unit 40.

When the image forming operation is started, the photosensitive drum 61 is rotated, a charging voltage is applied to the charging roller 62, and a surface of the photosensitive drum 61 is uniformly charged to a predetermined potential of predetermined polarity (negative polarity in the present Embodiment). The charged surface of the photosensitive drum 61 is scanned and exposed by being irradiated by a laser corresponding to image information by the scanner 2, and an electrostatic latent image (electrostatic image) corresponding to the image information is formed on the photosensitive drum 61.

The developing roller 71 is rotated with carrying the toner, and conveys the toner toward the photosensitive drum 61. In addition, to the developing roller 71, a developing voltage is applied. By this, the electrostatic latent image formed on the photosensitive drum 61 is developed (visualized) by the toner being supplied from the developing roller 71, and a toner image (developer image) is formed on the photosensitive drum 61. In the present Embodiment, the developing roller 71 develops the electrostatic latent image in a state in which the developing roller 71 is in contact with the photosensitive drum 61, however, the developing roller 71 may be configured so as to develop the electrostatic latent image in a state in which a gap is present between the photosensitive drum 61 and the developing roller 71. In the present Embodiment, to an exposed portion on the photosensitive drum 61, in which an absolute value of a potential is lowered by being exposed after having been uniformly charged, the toner charged to the charging polarity of the photosensitive drum 61 (negative polarity in the present Embodiment) is adhered (reverse development type). In the present Embodiment, a normal charging polarity of the toner, which is a main charging polarity of the toner during development, is negative polarity. For example, upon forming a full-color image, the toner images of respective colors of yellow, magenta, cyan and black are formed on the respective photosensitive drums 61Y, 61M, 61C and 61K.

Incidentally, in the present Embodiment, in the state in which the tray unit 50 is at the first inside position, the developing roller 71 is movable between a contact position, at which the developing roller 71 is in contact with the photosensitive drum 61, and a separated position, at which the developing roller 71 is separated from the photosensitive drum 61. Specifically, by a switching device provided in the apparatus main body 1A, a state in which the developing roller 71 is at the contact position and a state in which the developing roller 71 is at the separated position are switched. As a result, in a state in which the image forming operation is not performed, the developing roller 71 may be kept separated from the photosensitive drum 61.

In addition, the printer 1 may perform a mono-color printing, in a state in which the developing roller 71 corresponding to the cartridge PK and the photosensitive drum 61 are in contact, and the developing rollers 71 and the photosensitive drums 61 corresponding to the respective cartridges PY, PM and PC are separated. Upon the mono-color printing being performed, it is caused to be a state in which the photosensitive drum 61 corresponding to the respective cartridges PY, PM and PC and the intermediary transfer belt 41 are separated. In addition, the printer 1 can perform a full-color printing in a state in which the developing rollers 71 and the photosensitive drums 61 corresponding to the respective cartridges PY, PM, PC and PK are in contact with each other. Upon the full-color printing being performed, it is caused to be a state in which the photosensitive drum 61 corresponding to the respective cartridges PY, PM, PC and PK and the intermediary transfer belt 41 are in contact with each other.

The toner image formed on the photosensitive drum 61 is transferred (primarily transferred), in the primary transfer portion T1, by an action of the primary transfer roller 42, onto the rotating intermediary transfer belt 41. To the primary transfer roller 42, a primary transfer power source (not shown) as a primary transfer voltage applying portion is connected. During primary transfer, to the primary transfer roller 42, by the primary transfer power source, a primary transfer voltage (primary transfer bias) of opposite polarity to the normal charging polarity of the toner (positive polarity in the present Embodiment) is applied. For example, upon a full-color image being formed, the toner images of each color of yellow, magenta, cyan and black formed on the respective photosensitive drums 61 are sequentially transferred so as to be superimposed on the intermediary transfer belt 41. The toner images transferred onto the intermediary transfer belt 41 are conveyed, by the rotation of the intermediary transfer belt 41, toward the secondary transfer portion T2 formed by the intermediary transfer belt 41 and the secondary transfer roller 45. The toner (residual toner) which remains on the photosensitive drum 61 without being transferred to the intermediary transfer belt 41 during primary transfer is removed, by the cleaning blade 63, from the photosensitive drum 61 and is collected in a cleaning container provided in the cartridge P.

On the other hand, in the sheet feeding portion 30, from the sheets S stacked on the stacking tray 31, at a predetermined timing, by the pick roller 32a and the separating roller 32b, one sheet of the sheet S is separated and fed. This sheet S is conveyed through a conveyance path 1c toward the secondary transfer portion T2 and the fixing device 80.

The toner image on the intermediary transfer belt 41 is transferred (secondarily transferred), in the secondary transfer portion T2, by an action of the secondary transfer roller 45, onto the sheet S which is nipped and conveyed between the intermediary transfer belt 41 and the secondary transfer roller 45. To the secondary transfer roller 45, a secondary transfer power source (not shown) as a secondary transfer voltage applying portion is connected. During secondary transfer, to the secondary transfer roller 45, by the secondary transfer power source, a secondary transfer voltage (secondary transfer bias) of opposite polarity to the normal charging polarity of the toner (positive polarity in the present Embodiment) is applied. Incidentally, the driving roller 46 is electrically grounded. The toner (residual toner) which remains on the intermediary transfer belt 41 without being transferred to the sheet S during secondary transfer is removed, from the intermediary transfer belt 41 by the belt cleaning portion 43. The belt cleaning portion 43 includes a belt cleaning blade (cleaning member) 43A. The belt cleaning portion 43 scrapes off, with the belt cleaning blade 43A, the residual toner from the rotating intermediary transfer belt 41. The residual toner removed from the intermediary transfer belt 41 by the belt cleaning portion 43 is conveyed to a waste toner collecting container (not shown) as waste toner and collected.

The sheet S, onto which the toner image has been transferred in the secondary transfer portion T2, is conveyed toward the fixing device 80. The fixing device 80 heats and presses the sheet S bearing the unfixed toner image with the fixing portion 81, and fixes (melts, sticks) the toner image onto the sheet S. The sheet S, to which the toner image has been fixed, is conveyed toward the flapper 5 as a path switching portion. The flapper 5 is movable to a sheet discharging position at which the flapper 5 guides the sheet S, which has passed through the fixing portion 81, toward a sheet discharging path 1d and a reversing position at which the flapper 5 guides the sheet S toward a reversing path 1e. In a case in which a single-side printing, in which the image is formed on one side of the sheet S, is performed, the sheet S is guided to the discharging path 1d by the flapper 5, and is discharged to a discharge tray 1f formed on an upper portion of the apparatus main body 1A. On the other hand, in a case in which a double-side printing, in which the images are printed on the one side and a back side of the sheet S, is performed, the sheet S is guided to the reversing path 1e by the flapper 5. After the sheet S is guided to the reversing path 1e, the conveyance direction of the sheet S is reversed, and the sheet S is conveyed, through a double-side conveyance path 20a formed in the door 20, toward the secondary transfer portion T2. Then, in the secondary transfer portion T2, after the toner image is transferred to the back side of the sheet S, the sheet S passes through the fixing device 80, is guided to the discharging path 1d by the flapper 5, and is discharged to the discharge tray 1f of the apparatus main body 1A.

### Configuration around the registration roller pair and the secondary transfer portion

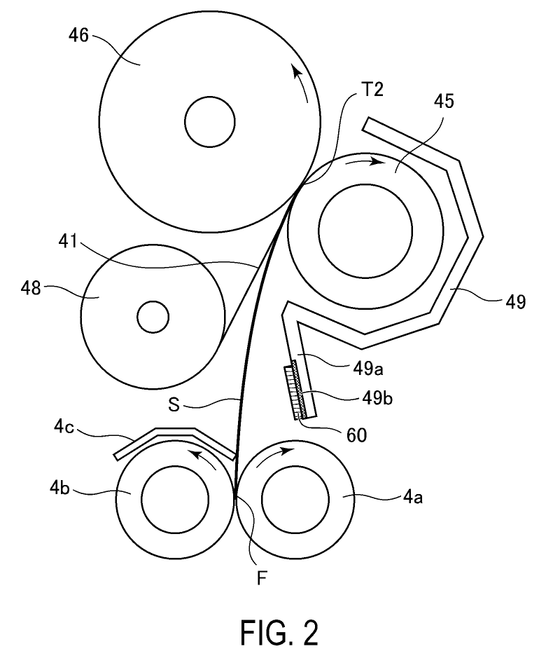

Next, using FIG. 2, a configuration around the registration roller pair 4 and the secondary transfer portion T2 in the present Embodiment will be described. FIG. 2 is a schematic cross-sectional view illustrating the configuration around the registration roller pair 4 and the secondary transfer portion T2 (illustrating a cross section approximately perpendicular to respective rotational axis directions of the registration roller pair 4 and the secondary transfer roller 45.).

As shown in FIG. 2, around the conveyance path of the sheet S from the registration roller pair 4 to the secondary transfer portion T2, the registration roller pair 4, the secondary transfer roller 45, the driving roller 46, the auxiliary roller 48, the intermediary transfer belt 41 and a secondary transfer roller holder 49 are provided.

The registration roller pair 4 is constituted by a registration roller 4a and a registration roller 4b, which are a pair of rotatable members (rotation members). The registration roller 4a contacts a surface of the sheet S opposite to the surface, onto which the toner image is to be transferred in the secondary transfer portion T2 immediately after the sheet S passes through the registration roller pair 4. The registration roller 4b contacts the surface of the sheet S, onto which the toner image is to be transferred in the secondary transfer portion T2 immediately after the sheet S passes through the registration roller pair 4.

The registration roller 4a is constituted by a roller which includes a core metal and an elastic layer provided around the core metal. In the present Embodiment, the elastic layer of the registration roller 4a is divided into a plurality of portions in the rotational axis direction (a longitudinal direction) of the registration roller 4a. In addition, the elastic layer of the registration roller 4a is composed of ethylene propylene rubber having a middle resistance. The core metal of the registration roller 4a is made of aluminum material (aluminum or aluminum alloy), which is metal material as a conductor (conductive material). The registration roller 4a is electrically (potentially) grounded (connected to a ground) via the core metal, so that it is suppressed that a surface of the registration roller 4a is charged. The registration roller 4a is rotated, by driving force from a driving source (not shown) being transmitted thereto, in a clockwise direction in FIG. 2. The rotational axis direction of the registration roller 4a is approximately parallel to the rotational axis direction of the secondary transfer roller 45.

The registration roller 4b is attached to a rotation shaft, which is approximately parallel to the rotational axis direction of the registration roller 4a, in a freely rotatable manner. The registration rollers 4b are provided at a plurality of positions opposing the elastic layers of the registration roller 4a. In the present Embodiment, the registration roller 4b is composed of polyacetal resin. The registration roller 4b is pressed, directly or via the sheet S, so as to be in contact with the registration roller 4a, toward the registration roller 4a. The registration roller 4b is rotated driven by rotation of the registration roller 4a. The registration roller pair 4 forms, by the registration roller 4a and the registration roller 4b being in contact with each other, a conveyance portion F which conveys the sheet S. In the present Embodiment, the registration roller pair 4 upwardly conveys the sheet S toward the secondary transfer portion T2 in the conveyance portion F.

A registration shutter 4c is provided, on an upper side of the registration roller 4b (downstream side of the registration roller 4b in the conveyance direction of the sheet S), so as to shield the registration roller 4b from the secondary transfer portion T2. The registration shutter 4c is formed of a sheet metal made of aluminum material, which is metal material as a conductor. In addition, the registration shutter 4c is pressed toward the registration roller 4b by a spring, which is an urging member as an urging means.

Incidentally, in the pick roller 32a (FIG. 1), a portion which contacts the sheet S is composed of rubber material (for example, ethylene propylene rubber).

The secondary transfer roller 45 is constituted by a roller which includes a core metal and an elastic layer provided around the core metal. The elastic layer of the secondary transfer roller 45 is composed of NBR + EPDM (acrylonitrile butadiene + ethylene propylene) rubber. The driving roller 46 is disposed at a position opposing the secondary transfer roller 45. The driving roller 46 is constituted by a roller which includes a core metal and an elastic layer provided around the core metal. The elastic layer of the driving roller 46 is composed of ethylene propylene rubber. The auxiliary roller 48 is constituted by a metal roller which is formed of aluminum material (aluminum alloy A6063S in the present Embodiment), which is metal material as a conductor. In addition, an inner surface layer which forms an inner peripheral surface of the intermediary transfer belt 41 is constituted by a conductive layer.

The secondary transfer roller holder 49 is a holding member which holds the secondary transfer roller 45 rotatably. The secondary transfer roller holder 49 also serves as a pre secondary transfer guide (guide member) 49a, which guides the sheet S conveyed toward the secondary transfer portion T2. In other words, to the secondary transfer roller holder 49, the pre secondary transfer guide 49a is integrally provided. The pre secondary transfer guide 49a is positioned, in the conveyance direction of the sheet S, on the downstream side of the conveyance portion F of the sheet S by the registration roller pair 4 and on the upstream side of the secondary transfer portion T2. The pre secondary transfer guide 49a is provided so as to oppose the surface of the sheet S, which is being nipped and conveyed by both the conveyance portion F and the secondary transfer portion T2, on the opposite side to the surface on which the toner image is to be transferred in the secondary transfer portion T2 immediately after the sheet S passes through the registration roller pair 4. The pre secondary transfer guide 49a contacts the leading end of the sheet S, for example, in a case in which a leading end in the conveyance direction of the sheet S is deviated from the conveyance path, regulates a moving direction of the sheet S, and guides the sheet S so as to head toward the secondary transfer portion T2. The secondary transfer roller holder 49 is composed of PC + ABS (polycarbonate + acrylonitrile butadiene styrene), which is resin material as an insulator (electric insulative material).

To at least a part of a surface of the pre secondary transfer guide 49a opposing the sheet S, a charge eliminating cloth 60 as a charge eliminating member for eliminating charge of the sheet S is attached. In the present Embodiment, the charge eliminating cloth 60 is a non-woven fabric in which fibers including conductive fibers are formed into a sheet shape. Incidentally, the charge eliminating cloth 60 may also be formed into a form different from the non-woven fabric, for example, a form in which the conductive fibers are woven into a woven fabric or a knitted fabric. However, the non-woven fabric is preferable for having many tip portions of the fibers to which electric charges are likely to be concentrated. In the present Embodiment, the charge eliminating cloth 60 is fixed on the pre secondary transfer guide 49a (a supporting surface 49b, which will be described below) by a double-sided tape. Incidentally, a fixing means of the charge eliminating cloth 60 is not limited to the double-sided tape, but the charge eliminating cloth 60 may be fixed by an arbitrary fixing means such as adhesion, welding and engagement by an engaging portion. In addition, in the present Embodiment, it is preferable to use a conductive one as the double-sided tape. In the present Embodiment, the charge eliminating cloth 60 is constituted by the non-woven fabric which includes a plurality of bristles (fibers), which are made of conductive nylon. In the present Embodiment, an electrical resistance value of the charge eliminating cloth 60 is 1.0 × 10⁵ Ω or less (typically 1.0 × 10⁴ Ω or more) in an environment of 23 ℃/50%. Incidentally, a configuration of the charge eliminating cloth 60 is not limited to the one in the present Embodiment. For example, as the charge eliminating cloth 60, one formed by applying a conductive paint, in which carbon is dispersed in binder of acrylic resin, to a non-woven fabric of polyethylene terephthalate fibers may be used.

A size of the charge eliminating cloth 60 is set in accordance with a width (maximum width) of the sheet S of a maximum size, which is conveyable by the printer 1, in a direction approximately perpendicular to the conveyance direction of the sheet S. In the present Embodiment, in the charge eliminating cloth 60, a length in a longitudinal direction, which is approximately parallel to the widthwise direction of the sheet S, is 300 mm, and a length in a widthwise direction, which is approximately parallel to the conveyance direction of the sheet S, is 5.0 mm. In other words, in the present Embodiment, the length in the longitudinal direction of the charge eliminating cloth 60 is longer than the maximum width (A4 width) of the sheet S, and a range of the maximum width of the sheet S falls within a range of the length of the charge eliminating cloth 60 in the longitudinal direction thereof. In the present Embodiment, the charge eliminating cloth 60 is a sheet-like member which is approximately rectangular in a planar view. In addition, in the present Embodiment, the charge eliminating cloth 60 is electrically floated. In addition, in the present Embodiment, a shortest distance between the sheet S, which is nipped and conveyed by both the conveyance portion F and the secondary transfer portion T2, and the charge eliminating cloth 60 (here, also referred to simply as “distance between the sheet S and the charge eliminating cloth 60”) is 6.0 mm.

The supporting surface 49b of the pre secondary transfer guide 49a as a supporting member (charge elimination supporting member), which supports the charge eliminating cloth 60, is formed of a sheet metal of aluminum material, which is metal material as a conductor. The sheet metal constituting the supporting surface 49b may be fixed, by an arbitrary fixing means such as fixing by a double-sided tape, adhesion, welding and engagement by an engaging portion, to the pre secondary transfer guide 49a. Incidentally, the supporting surface 49b and a surface of the sheet-like charge eliminating cloth 60 are approximately parallel to each other. In the present Embodiment, the supporting surface 49b is electrically floated. By constituting the supporting surface 49b with a conductor, it becomes possible to enhance charge eliminating efficiency of the sheet S with the charge eliminating cloth 60. The charge eliminating cloth 60 and the conveyance path of the sheet S are opposing. Here, “oppose” means that a normal line of the supporting surface 49b and the conveyance path of the sheet S cross, between the registration roller pair 4 and the secondary transfer nip T2, without crossing other members. Incidentally, the charge elimination means removing at least a part of electric charge.

In the present Embodiment, the registration roller pair 4 upwardly conveys the sheet S toward the secondary transfer portion T2 in the conveyance portion F. Then, in the present Embodiment, the conveyance path of the sheet S from the conveyance portion F to the secondary transfer portion T2 is approximately vertical, and in a position where the normal line of the supporting surface 49b crosses itself, the surface of the recording material S being conveyed by both the conveyance portion F and the transfer portion T2 is approximately parallel to the direction of gravity.

Here, the insulator (electric insulative material) refers to a substance of which a volume resistivity is 10⁸ Ω m or more, and preferably 10¹⁰ Ω m or more. However, typically, the insulator has the volume resistivity of about 10¹⁶ Ω m or less. In addition, the conductor (conductive material) refers to a substance of which a volume resistivity is 10⁻⁶ Ω m or less, and typically about 10⁻⁸ Ω m.

### Effect of the charge eliminating cloth

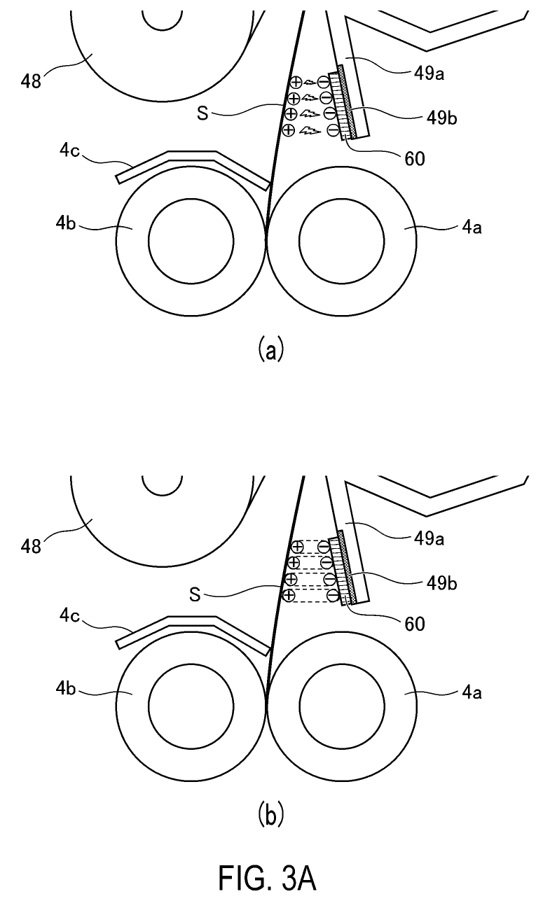

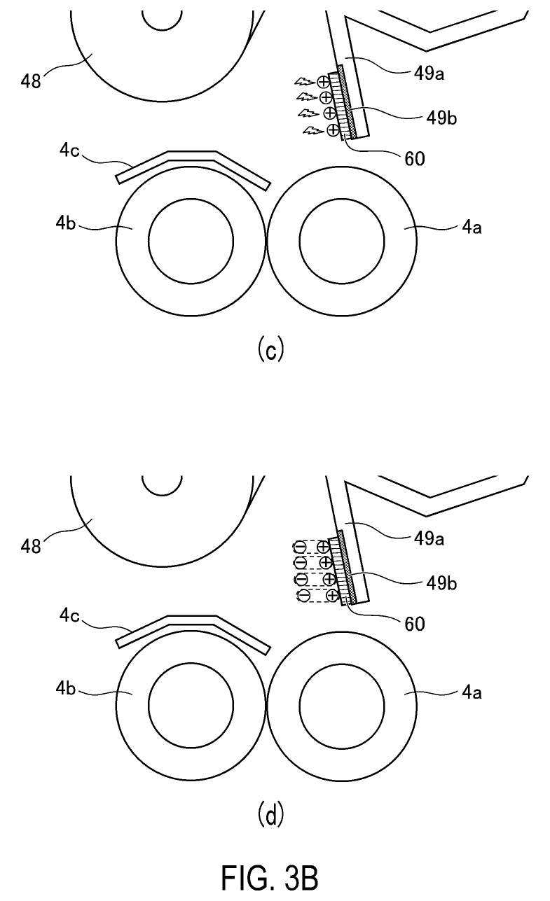

Next, using FIG. 3, effect of the charge eliminating cloth 60 in the present Embodiment will be described. FIGS. 3, part (a), part (b), part (c) and part (d), includes schematic cross-sectional views illustrating the configuration about the registration roller pair 4 and the secondary transfer portion T2 for describing the effect of the charge eliminating cloth 60 (illustrating cross sections approximately perpendicular to the respective rotational axis directions of the registration roller pair 4 and the secondary transfer roller 45.). FIG. 3 is, for convenience, divided into FIGS. 3A and FIG. 3B. Here, it will be described by using figure numbers of part (a) of FIGS. 3A through part (d) of 3B shown in FIGS. 3A and FIG. 3B.

A position of the sheet S in a charging series (triboelectric charging series) is, with respect to positions of the materials of portions of the pick roller 32a and the registration roller pair 4 contacting the sheet S in the charging series, on a positive side. Therefore, by friction with the pick roller 32a and the registration roller pair 4, positive electric charge is accumulated on the sheet S. In this manner, by the positive electric charge being accumulated on the sheet S, on the charge eliminating cloth 60 disposed so as to oppose the sheet S, typically on the tip portions of bristles (bristle tips) which constitute the charge eliminating cloth 60, negative electric charge is induced. As shown in part (a) of FIG. 3A, when a potential of the sheet S becomes a potential of a predetermined value or more, corona electric discharge occurs between the tip portion of bristle of the charge eliminating cloth 60 and the sheet S. By the corona electric discharge occurring, gas molecules in air are ionized, and anion is generated around the tip portions of bristles of the charge eliminating cloth 60. This anion is coupled, as shown in part (b) of FIG. 3A, with the positive electric charge accumulated on the sheet S.

By this, the electric charge of the sheet S, which has passed through the charge eliminating cloth 60, is eliminated. The charge eliminating cloth 60, which is electrically floated, has a tendency to be charged to positive polarity by eliminating the electric charge of the sheet S. However, as shown in part (c) of FIG. 3B, when the sheet S is not present at the position opposing the charge eliminating cloth 60 until a next sheet S is fed and conveyed, by aerial electric discharge occurring from the tip portions of bristles of the charge eliminating portion 60, anion is generated. By this anion being coupled, as shown in part (d) of FIG. 3B, with the positive electric charge of the charge eliminating cloth 60, the potential of the charge eliminating cloth 60 is attenuated. Therefore, even during continuous printing, by a time when a next sheet S is conveyed to the position opposing the charge eliminating cloth 60, the positive potential of the charge eliminating cloth 60 is sufficiently attenuated, and the charge eliminating cloth 60 can continue to sufficiently exhibit the charge eliminating effect.

To the charge eliminating effect by the charge eliminating cloth 60, the distance between the sheet S and the charge eliminating cloth 60 and an area of the surface of the charge eliminating cloth 60 opposing the sheet S affect. In a case in which the distance between the sheet S and the charge eliminating cloth 60 is long, a generated amount of the corona electric discharge is decreased, so that a sufficient anion may not be supplied. In addition, in a case in which the area of the surface of the charge eliminating cloth 60 opposing the sheet S is small, a number of bristles of the charge eliminating cloth 60, which contribute to the charge elimination of the sheet S, is reduced, so that the charge eliminating effect may be weakened. In a case in which the electric discharge of the sheet S is not sufficiently eliminated, image defect due to abnormal electric discharge in the secondary transfer portion T2 may occur.

### Experiment A on the effect of the charge eliminating cloth comparison of frequency of occurrence of image defect due to the abnormal electric discharge

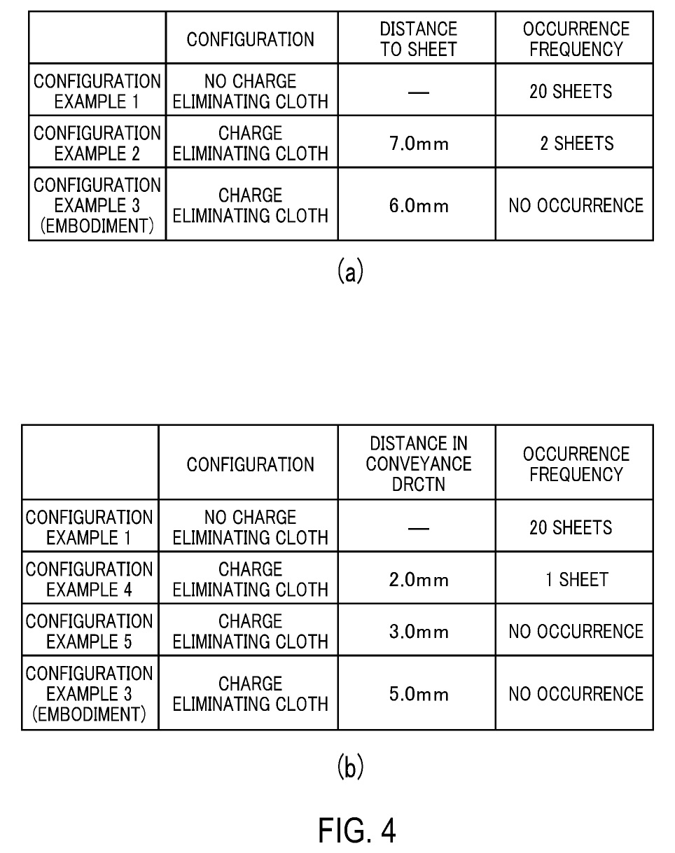

On the effect of the charge eliminating cloth 60, an Experiment A was conducted by using the printer 1. In the Experiment A, the sheets S are set on the stacking tray 31, and frequency of occurrence (occurrence rate) of the image defect, upon performing formation of a halftone image of black with a density of 50% (density of a solid image, of which a toner application amount is maximum, is defined as 100%.) for one hundred sheets continuously, is examined. In addition, in the Experiment A, with varying the distance between the sheet S and the charge eliminating cloth 60, the frequency of occurrence of the image defect is examined. As the sheet S, PBPAPER (marketed by Canon Marketing Japan Inc.) is used. An experiment environment is set to under a normal temperature and a low humidity of an atmospheric temperature of 25 ℃ and a relative humidity of 5%. For the Experiment, the sheets S (PBPAPER) which are left for ten days on a wire rack at a stacking height of 10 mm or less under the normal temperature and the low humidity are used. The Experiment was conducted also for a case in which the charge eliminating cloth 60 was not provided. Configurations of respective Examples are substantially the same, except for presence/absence of the charge eliminating cloth 60 and the distance between the sheet S and the charge eliminating cloth 60. Results are shown in part (a) of FIG. 4.

Configuration Example 1: In the case in which the charge eliminating cloth 60 was not provided, the image defect, which seems to be due to the abnormal electric discharge in the secondary transfer portion T2, such that the halftone image of black is partially void, occurred at a high frequency of twenty sheets per one hundred sheets.

Configuration Example 2: In a case in which the distance between the sheet S and the charge eliminating cloth 60 was 7.0 mm, the image defect occurred at a frequency of two sheets per one hundred sheets.

Configuration Example 3 (the present Embodiment): In the case in which the distance between the sheet S and the charge eliminating cloth 60 was 6.0 mm, the occurrence of the image defect per one hundred sheets was not observed.

As it can be seen from the results of the Experiment A, etc., in the configuration of the printer 1 in the present Embodiment, in order to suppress the image defect due to the abnormal electric discharge in the secondary transfer portion T2, it is preferable that the distance between the sheet S and the charge eliminating cloth 60 be 6.0 mm or less. As it can be seen from measurement results of the charge amount of the sheet S, which will be described below, etc., by further shortening the distance between the sheet S and the charge eliminating cloth 60, it is possible to further enhance the charge eliminating effect. For example, it is more preferable that the distance between the sheet S and the charge eliminating cloth 60 be 4.0 mm or less, and it is further preferable that the distance be 2.0 mm or less. However, from a viewpoint such as suppressing leakage of secondary transfer current, the sheet S and the charge eliminating cloth 60 are configured to be substantially in a non-contact manner. In other words, in the configuration of the printer 1 in the present Embodiment, it is preferable that the distance between the sheet S and the charge eliminating cloth 60 be larger than 0 mm and 6.0 mm or less. Incidentally, it is sufficient that the sheet S, which is being nipped and conveyed by both the conveyance portion F and the secondary transfer portion T2, and the charge eliminating cloth 60 are in non-contact principally, and for example, the leading end (or a trailing end) of the sheet S in the conveyance direction thereof may sometimes contact the charge eliminating cloth 60.

In addition, with varying the length of the charge eliminating cloth 60 in the conveyance direction of the sheet S (length in the widthwise direction), comparison of the frequency of occurrence of the image defect was conducted under the same condition as the Experiment described above. Configurations of respective Examples are substantially the same, except for the presence/absence of the charge eliminating cloth 60 and the length of the charge eliminating cloth 60 in the conveyance direction of the sheet S. Results are shown in part (b) of FIG. 4.

Configuration Example 1: In a case in which the length of the charge eliminating cloth 60 in the conveyance direction of the sheet S was 0 mm, i.e., in the case in which the charge eliminating cloth 60 was not provided, similarly to the Experiment described above, the image defect, which seems to be due to the abnormal electric discharge in the secondary transfer portion T2, occurred at the frequency of twenty sheets per one hundred sheets.

Configuration Example 4: In a case in which the length of the charge eliminating cloth 60 in the conveyance direction of the sheet S was 2.0 mm, the image defect occurred at a frequency of one sheet per one hundred sheets.

Configuration Example 5: In a case in which the length of the charge eliminating cloth 60 in the conveyance direction of the sheet S was 3.0 mm, the occurrence of the image defect per one hundred sheets was not observed.

Configuration Example 3 (present Embodiment): In the case in which the length of the charge eliminating cloth 60 in the conveyance direction of the sheet S was 5.0 mm, the occurrence of the image defect per one hundred sheets was not observed.

As it can be seen from the results described above, etc., in the configuration of the printer 1 in the present Embodiment, it is preferable that the length of the charge eliminating cloth 60 in the conveyance direction of the sheet S be 3.0 mm or more. There is no upper limit for the length of the charge eliminating cloth 60 in the conveyance direction of the sheet S, however, it is often the case that 10.0 mm or less is sufficient, and typically it can be said that 5.0 mm is sufficient.

### Experiment B on the effect of charge eliminating cloth comparison of the charge amount of the sheet

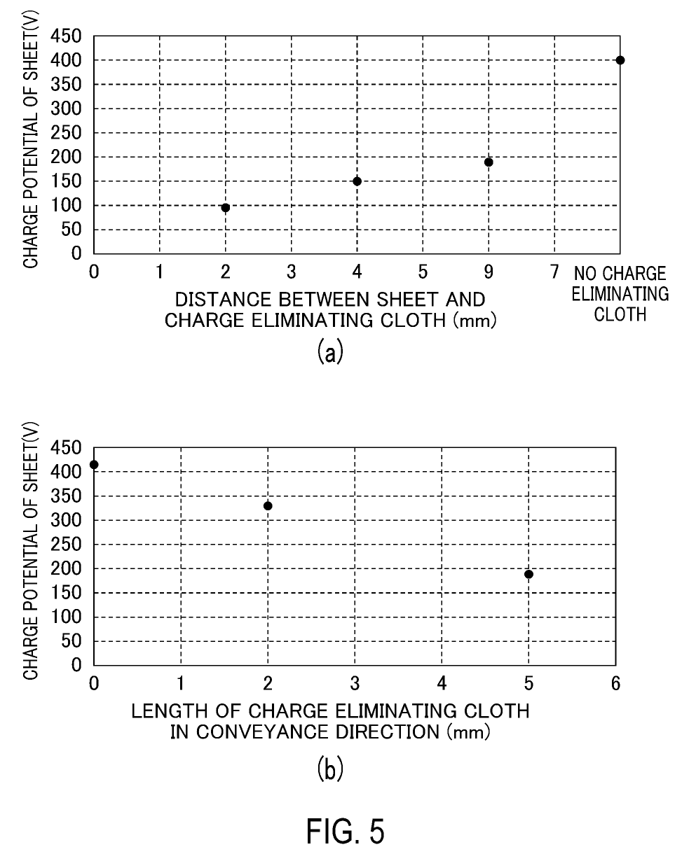

Next, an Experiment B in which the charge amount of each sheet S was measured was conducted. The image forming operation by using the printer 1 is performed under the same conditions as the Experiment A, after the sheet S passed through the registration roller pair 4, the printer 1 is emergently stopped and the sheet S is taken out to an outside of the apparatus, and then the charge amount of the sheet S (a surface potential of the sheet S) immediately before being conveyed to the secondary transfer portion T2 is measured. The sheet S is disposed on an aluminum sheet metal, which is electrically grounded, and the surface potential (a charged potential) of the sheet S at a position where the pick roller 32a contacts in the stacking tray 31 is measured with a surface potential meter (surface potential meter Model 370 manufactured by Trek). Configurations of respective Examples are substantially the same, except for the presence/absence of the charge eliminating cloth 60 and the distance between the sheet S and the charge eliminating cloth 60. Results are shown in part (a) of FIG. 5.

In the case in which the charge eliminating cloth 60 was not provided, the surface potential of the sheet S at the portion having contacted the pick roller 32a was +400 V. In addition, the surface potential of the sheet S at a portion not having contacted the pick roller 32a was about +15 V.

On the other hand, in the case in which the charge eliminating cloth 60 was provided, the surface potential of the sheet S showed a tendency to decrease. In the case (present Embodiment) in which the distance between the sheet S and the charge eliminating cloth 60 was 6.0 mm, the surface potential of the sheet S was +200 V. Furthermore, in the case in which the distance between the sheet S and the charge eliminating cloth 60 was shortened to 2.0 mm, the surface potential of the sheet S was +100 V.

In addition, with the distance between the sheet S and the charge eliminating cloth 60 being fixed to 6.0 mm and the area of the surface of the charge eliminating cloth 60 opposing the sheet S, i.e., the length of the charge eliminating cloth 60 in the conveyance direction of the sheet S (length in the widthwise direction thereof) being varied, the charge amount of the sheet S (surface potential of the sheet S) was measured. Experiment conditions and experiment methods are the same as those of the Experiments described above. In addition, configurations of respective Examples are substantially the same, except for the presence/absence of the charge eliminating cloth 60 and the lengths of the charge eliminating cloth 60 in the conveyance direction of the sheet S. Results are shown in part (b) of FIG. 5.

In the case in which the length of the charge eliminating cloth 60 in the conveyance direction of the sheet S was 0 mm, i.e., in the case in which the charge eliminating cloth 60 was not provided, the surface potential of the sheet S was +400 V. In the case in which the length of the charge eliminating cloth 60 in the conveyance direction of the sheet S was 2.0 mm, the surface potential of the sheet S was +300 V. In addition, in the case (present Embodiment) in which the length of the charge eliminating cloth 60 in the conveyance direction of the sheet S was 5.0 mm, the surface potential of the sheet S was +150 V.

### Mechanism of the occurrence of the image defect due to the abnormal electric discharge in the secondary transfer portion

From the results of the Experiment A and the Experiment B, etc., it is considered that a mechanism of the occurrence of the image defect due to the abnormal electric discharge in the secondary transfer portion T2 is as follows. That is, it is considered that the following (1) through (4) occur in order.
(1) The sheet S, which is fed and conveyed from the stacking tray 31, is charged to positive polarity by friction with the pick roller 32a from a first sheet.
(2) Upon the sheet S entering the secondary transfer portion T2, electric discharge occurs between the sheet S and the toner charged to negative polarity, which constitutes the toner image (halftone image) on the intermediary transfer belt 41.
(3) Due to the electric discharge, the toner image (halftone image) on the intermediary transfer belt 41 is disturbed.
(4) In the toner image (halftone image) transferred onto the sheet S, the image defect, which is due to the abnormal electric discharge in the secondary transfer portion T2, such that the toner image is partially void, occurs.

By providing the charge eliminating cloth 60 so as to oppose the sheet S before entering the secondary transfer portion T2, it becomes possible to eliminate the charge of the sheet S charged to positive polarity. By this, it becomes possible to suppress the electric discharge between the sheet S and the toner on the intermediary transfer belt 41. Therefore, it becomes possible to suppress the occurrence of the image defect due to the abnormal electric discharge in the secondary transfer portion T2.

In the present Embodiment, on the pre secondary transfer guide 49a between the registration roller pair 4 and the secondary transfer portion T2, the charge eliminating cloth 60, which is in non-contact with the sheet S, is provided. By this, it becomes possible to eliminate the charge of the sheet S charged by the sheet feeding portion 30 and the registration roller pair 4, and suppress that the image defect due to the abnormal electric discharge in the secondary transfer portion T2 occurs. In addition, by shortening the distance between the sheet S and the charge eliminating cloth 60 and/or increasing the area of the surface of the charge eliminating cloth 60 opposing the sheet S, it becomes possible to obtain a higher charge eliminating effect, so that the charge amount of the sheet S can be further reduced.

Incidentally, the distance between the sheet S and the charge eliminating cloth 60 and the area of the surface of the charge eliminating cloth 60 opposing the sheet S are not limited to the values in the present Embodiment, but may be changed, for example, depending on a density of the fibers of the charge eliminating cloth 60, and a length of the bristles.

### Paper dust contamination suppressing effect for the charge eliminating cloth

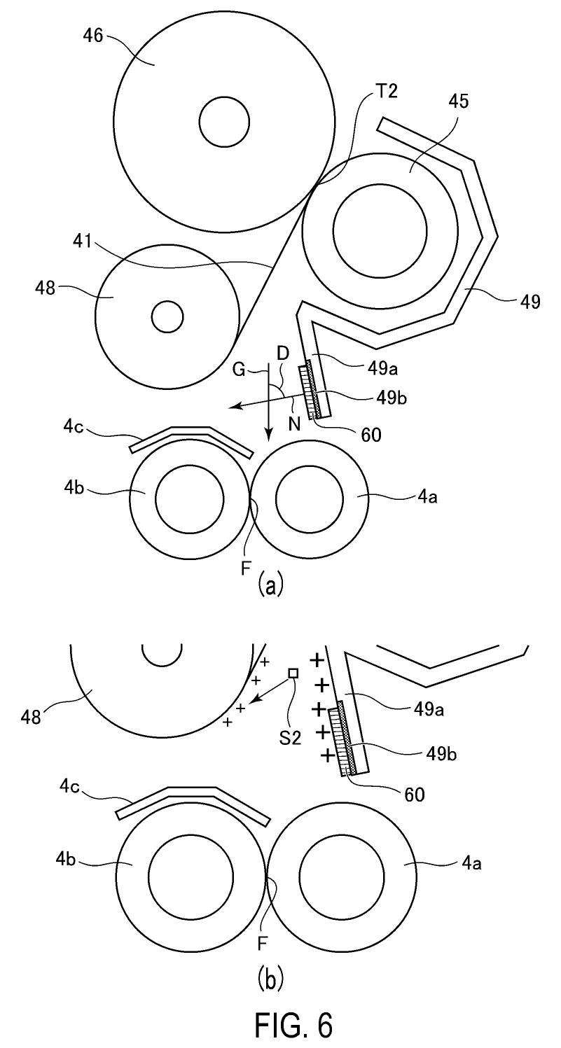

Next, using FIG. 6, paper dust contamination suppressing effect for the charge eliminating cloth 60 in the present Embodiment will be described. FIGS. 6, part (a) and part (b), includes schematic cross-sectional views illustrating the configuration around the registration roller pair 4 and the secondary transfer portion T2 for describing the paper dust contamination suppressing effect for the charge eliminating cloth 60 (illustrating the cross section approximately perpendicular to respective rotational axis directions of the registration roller pair 4 and the secondary transfer roller 45.).

In the present Embodiment, mainly, by the following two actions, contamination due to paper dust in the charge eliminating cloth 60 (here, also referred to simply as “paper dust contamination”) is suppressed.

A first one is suppression of the paper dust contamination by adjustment of an angle at which the charge eliminating cloth 60 is disposed. As shown in part (a) of FIG. 6, the supporting surface 49b of the charge eliminating cloth 60 provided on the pre secondary transfer guide 49a is configured so that an angle D, which a normal line N of the supporting surface 49b forms with a direction of gravity G, becomes less than 90 degrees. By this, the charge eliminating cloth 60 is disposed so that the surface of the charge eliminating cloth 60 opposing the sheet S (here, also referred to as a “charge eliminating surface”) faces downward. Therefore, it becomes possible to suppress that the paper dust falling from above the charge eliminating cloth 60 is accumulated on the charge eliminating surface of the charge eliminating cloth 60.

A second one is suppression of the paper dust contamination by control of the potential of the charge eliminating cloth 60. The position of the sheet S in the charging series (triboelectric charging series) is, with respect to the positions of the materials of portions of the pick roller 32a and the registration roller pair 4contacting the sheet S in the charging series, on the positive side. Therefore, the sheet S between the registration roller pair 4 and the secondary transfer portion T2 is significantly charged to a positive side. Potential of the paper dust immediately after being separated from the sheet S is the same positive potential as the sheet S immediately before being separated. Therefore, the paper dust exhibits, by an electrostatic force, between the charge eliminating cloth 60 and elements (in the present Embodiment, the intermediary transfer belt 41 and the auxiliary roller 48) of the intermediary transfer unit 40 as opposing members, which are disposed so as to oppose the charge eliminating cloth 60, a behavior approaching a unit, of which potential is more on a negative side. Incidentally, it can be said that the intermediary transfer belt 41 is the opposing member which is disposed at a position opposing the charge eliminating cloth 60, and that the auxiliary roller 48 is the opposing member which is disposed at a position opposing the charge eliminating cloth 60 via the intermediary transfer belt 41.

Therefore, as shown in part (b) of FIG. 6, by controlling the potential so that the paper dust (S2 in part (b) of FIG. 6) receives force in a direction going away from the charge eliminating cloth 60, it becomes possible to cause the paper dust S2 to go away from the charge eliminating cloth 60, and suppress the paper dust contamination in the charge eliminating cloth 60.

### Experiment C on the paper dust contamination suppressing effect the angle at which the charge eliminating cloth is disposed

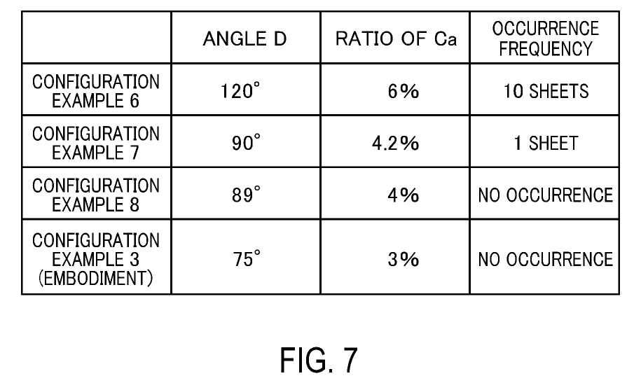

First, on the suppression of the paper dust contamination, in order to verify an effect by disposing the charge eliminating cloth 60 so as to face downward, an Experiment C was conducted by using the printer 1. In the Experiment C, the frequency of occurrence of the image defect is confirmed as follows. That is, the sheets S are set on the stacking tray 31, and formations of a black horizontal line image with a printing ratio of 5% (a case in which all pixels in an image forming area are printing portions is defined as 100%.) are continuously performed for one hundred thousand sheets. Thereafter, when formations of a halftone image of black with a density of 60% for one hundred sheets are performed, the frequency of occurrence of the image defect is examined. In addition, in the Experiment C, with varying the angle D of the supporting surface 49b, on which the charge eliminating cloth 60 is disposed, with respect to the direction of gravity G, a degree of contamination in the charge eliminating cloth 60 after the sheet passing is examined. In the Experiment C, for the one hundred thousand sheets of the continuous sheet passing, Canon Red Label (marketed by Canon Marketing Japan Inc.) is used as the sheet S. In addition, in the Experiment C, for the examination of the frequency of occurrence of the image defect, as the sheet S, the PBPAPER which is left for ten days on the wire rack at the stacking height of 10 mm or less under the normal temperature and the low humidity is used. An experiment environment is set to under a normal temperature and a low humidity of an atmospheric temperature of 23° C and a relative humidity of 5%. In the Experiment C, the potential of the charge eliminating cloth 60 is set to be floated in all examples. Configurations of the respective examples are substantially the same, except for the angle D. Results are shown in FIG. 7.

Configuration Example 6: In a case in which the angle D = 120 degrees, the image defect, which seems to be due to the abnormal electric discharge in the secondary transfer portion T2, occurred at a frequency of ten sheets per one hundred sheets.

Configuration Example 7: In a case in which the angle D = 90 degrees, the image defect occurred at a frequency of one sheet per one hundred sheets.

Configuration Example 8: In a case in which the angle D = 89 degrees, the occurrence of the image defect per one hundred sheets was not observed.

Configuration Example 3 (present Embodiment): In a case in which the angle D = 75 degrees, the occurrence of the image defect per one hundred sheets was not observed.

Next, in order to quantify an amount of the paper dust accumulated on the charge eliminating cloth 60, an X-ray fluorescence measurement was conducted. For the measurement, a handy X-ray fluorescence measuring meter (a handheld X-ray fluorescence analyzer Vanta Max manufactured by Olympus Corporation) is used. With respect to the charge eliminating cloth 60 in the respective examples after the experiment, a proportion, in which Ca (calcium), which is one of constituent elements of paper, is included, is measured and compared. Results are shown in FIG. 7.

As shown in FIG. 7, the proportion of Ca was 6% in the Configuration Example 6, 4.2% in the Configuration Example 7, 4% in the Configuration Example 8, and 3% in the Configuration Example 3 (present Embodiment). From this result, it can be seen that there is a possibility that in a case in which the proportion of Ca is higher than about 4%, by the paper dust obstructing the corona electric discharge at the bristle tip of the charge eliminating cloth 60, the charge eliminating efficiency is lowered, so that it becomes difficult to maintain a sufficient charge eliminating effect for suppressing the image defect. In other words, in order to maintain the charge eliminating effect of the charge eliminating cloth 60 more favorably, it is preferable that the proportion of Ca be 5% or less, and it is more preferable that the proportion be 4% or less. Incidentally, since the toner is sufficiently small, the toner is accumulated not on the bristle tip of the charge eliminating cloth 60 but between the bristles, and does not obstruct the corona electric discharge from the bristle tip, and therefore does not need to be considered.

As it can be seen from the results of the Experiment C, etc. by disposing the charge eliminating cloth 60 so that the angle D becomes less than 90 degrees, it becomes possible to suppress that the paper dust falling from above the charge eliminating cloth 60 contacts the charge eliminating surface of the charge eliminating cloth 60, and suppress that the paper dust is accumulated on the charge eliminating cloth 60. By this, even at an end of life of the printer 1 (or a unit including the secondary transfer roller 45 and the secondary transfer roller holder 49), it becomes possible to maintain the charge eliminating effect of the charge eliminating cloth 60. In addition, by further reducing a magnitude of the angle D, it becomes possible to further reduce the amount of the paper dust contamination. From the results of the Experiment C, etc., the angle D is preferably 80 degrees or less, and more preferably 75 degrees or less. However, from viewpoints such as sufficiently maintaining the function of the pre secondary transfer guide 49a to guide the sheet S and sufficiently causing the charge eliminating surface of the charge eliminating cloth 60 to oppose the sheet S, it is appropriate that the angle D be 45 degrees or more, preferably 60 degrees or more, and further preferably 70 degrees or more.

### Experiment D on the effect of suppressing the paper dust contamination control of a falling direction of the paper dust by an electric field

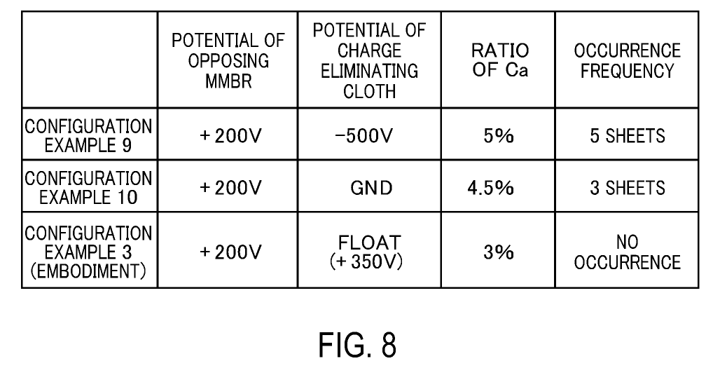

Next, on the suppression of the paper dust contamination, in order to verify effect by controlling a falling direction of the paper dust by an electric field, an Experiment D was conducted. Under the same conditions as the Experiment C, with varying the potential of the charge eliminating cloth 60, the frequency of occurrence of the image defect after the continuous sheet passing of one hundred thousand sheets is examined. In the Experiment D, the angle D is fixed to 75 degrees. In addition, a potential of the secondary transfer roller 45 during sheet passing is set to +4000 V, and a potential of the auxiliary roller 48 during sheet passing is set to +200 V. Incidentally, the auxiliary roller 48 is an example of the opposing member disposed at the position opposing the charge eliminating cloth 60. And the auxiliary roller 48 is constituted by the metal roller, and is at approximately the same potential as the intermediary transfer belt 41, which is an example of the opposing member disposed at the position opposing the charge eliminating cloth 60. Configurations of respective examples are substantially the same, except for the potential of the charge eliminating cloth 60. Results are shown in FIG. 8.

Configuration Example 9: In a case in which the charge eliminating cloth 60 was charged to -500 V, the image defect, which seems to be due to the abnormal electric discharge in the secondary transfer portion T2, occurred at a frequency of five sheets per one hundred sheets.

Configuration Example 10: In a case in which the charge eliminating cloth 60 was electrically grounded, the image defect occurred at a frequency of three sheets per one hundred sheets.

Configuration Example 3 (present Embodiment): In the case in which the charge eliminating cloth 60 was electrically floated, the occurrence of the image defect per one hundred sheets was not observed.

In addition, in the configuration in the present Embodiment, change in the potential of the charge eliminating cloth 60 during sheet passing of twenty sheets of Canon Red Label was measured as follows. By taking out a conducting wire, which is connected to the charge eliminating cloth 60, to an outside of the apparatus main body 1A, connecting the conducting wire to an aluminum sheet metal, and using the surface potential meter (surface potential meter Model 370 manufactured by Trek), a potential of the aluminum sheet metal is measured. Through this, the change in the potential of the charge eliminating cloth 60 during sheet passing of twenty sheets described above is measured. The potential of the charge eliminating cloth 60 rose to the positive side during sheet passing, and rose up to +350 V. In a case in which the potential of the sheet S is high, an attenuating speed of the potential of the charge eliminating cloth 60 in a sheet interval becomes smaller than a rising speed of the potential of the charge eliminating cloth 60 due to eliminating the charge of the sheet S (the attenuating speed of the potential < the rising speed of the potential), so that the potential of the charge eliminating cloth 60 rises to the positive side. Incidentally, "the sheet interval" is a period corresponding to an interval between a preceding sheet S and a subsequent sheet S during continuous printing.

Next, similarly to the case of the Experiment C, the X-ray fluorescence measurement of the charge eliminating cloth 60 after the experiment was conducted. Results are shown in FIG. 8.

As shown in FIG. 8, the proportion of Ca was 5% in the Configuration Example 9, 4.5% in the Configuration Example 10, and 3% in the Configuration Example 3 (present Embodiment). In the Configuration Example 9 and the Configuration Example 10, since the proportion of Ca exceeds 4%, it is considered that there is a case in which the image defect occurred. In the Configuration Example 3 (present Embodiment), since the proportion of Ca is below 4%, it is considered that the image defect did not occur. However, in the Configuration Example 9 and the Configuration Example 10, similarly to the Configuration Example 3 (present Embodiment), since the angle D is set to 75 degrees, as compared with the Configuration Example 6 described above, it can be seen that the paper dust contamination could be suppressed. In this manner, by setting the angle D and the potential of the charge eliminating cloth 60 in accordance with the present invention, it becomes possible to enhance the effect to suppress the paper dust contamination synergistically. However, by setting at least the angle D of the angle D and the potential of the charge eliminating cloth 60 in accordance with the present invention, it becomes possible to obtain an appropriate effect to suppress the paper dust contamination.

On the control of the falling direction of the paper dust by the electric field will be further described. In the cases of the Configuration Example 9 and the Configuration Example 10, during sheet passing, the potential of the charge eliminating cloth 60 becomes lower than the potential of the intermediary transfer belt 41 (auxiliary roller 48) as the opposing member of the charge eliminating cloth 60 (the potential of the charge eliminating cloth 60 < the potential of the intermediary transfer belt 41 (auxiliary roller 48)). On the other hand, in the Configuration Example 3 (present Embodiment), during sheet passing, the potential of the charge eliminating cloth 60 becomes higher than the potential of the intermediary transfer belt 41 (auxiliary roller 48) as the opposing member of the charge eliminating cloth 60 (the potential of the charge eliminating cloth 60 > the potential of the intermediary transfer belt 41 (auxiliary roller 48)). As it can be seen from the experiment results, in the case of “the potential of the charge eliminating cloth 60 > the potential of the intermediary transfer belt 41”, it becomes possible to suppress the paper dust contamination in the charge eliminating cloth 60 more favorably, and suppress the occurrence of the image defect more favorably. In other words, the paper dust, which is positively charged, receives force, since the paper dust is attracted to a member of which the potential is low by electrostatic force, in a direction going away from the charge eliminating cloth 60. As a result, it becomes possible to reduce the paper dust contamination in the charge eliminating cloth 60, and enhance the effect to maintain the charge eliminating effect.

As long as the potential relationship of “the potential of the charge eliminating cloth 60 > the potential of the opposing member” is satisfied, the opposing member is not limited to the element of the intermediary transfer unit 40 (in the present Embodiment, the intermediary transfer belt 41 and the auxiliary roller 48). For example, the opposing member may be a sheet conveyance guide. In addition, the auxiliary roller 48 may be electrically grounded. In addition, in the present Embodiment, the charge eliminating cloth 60 is electrically floated, however, as long as the potential relationship described above is satisfied, the charge eliminating cloth 60 may be electrically grounded. In a case in which the charge eliminating cloth 60 is electrically grounded, it is desired that the potential of the opposing member is set lower than in the present Embodiment.

In this manner, in the present Embodiment, the image forming apparatus (printer) 1 includes the image bearing member (intermediary transfer belt) 41 which bears the toner image, the transfer member (secondary transfer roller) 45 which forms the transfer portion (secondary transfer portion) T2 to transfer the toner image from the image bearing member 41 to the recording material S by being in contact with the image bearing member 41 and to convey the recording material S in the transfer portion T2, the feeding portion (stacking tray) 31 on which the recording material S is placed, the feeding member (pick roller) 32a which feeds the recording material S placed on the feeding portion 31 from the feeding portion 31 to the transfer portion T2, the conveyance member (registration roller pair) 4 which forms the conveyance portion F to convey the recording material S fed from the feeding portion 31 and to upwardly convey the recording material S toward the transfer portion T2, the sheet-like charge eliminating cloth 60 which eliminates the charge of the recording material S on the downstream of the conveyance portion F and on the upstream of the transfer portion T2 in the conveyance direction of the recording material S, and is disposed so as to oppose the surface of the recording material S being conveyed by both the conveyance portion F and the transfer portion T2 in the non-contact manner, and the supporting member (pre secondary transfer guide) 49a provided with the supporting surface 49b to support the charge eliminating cloth 60, and the angle formed by the normal line of the supporting surface 49b and the direction of gravity is 45 degrees or more and less than 90 degrees. In addition, in the present Embodiment, the image forming apparatus 1 further includes the opposing member which opposes the charge eliminating cloth 60 via the recording material S being conveyed by both the conveyance portion F and the transfer portion T2, and the charge eliminating cloth 60 is charged so that the potential of the charge eliminating cloth 60 becomes the high potential on the positive polarity side to the potential of the opposing member by eliminating the charge of the recording material S being fed from the feeding portion 31 to the transfer portion T2 by the charge eliminating cloth 60. In particular, in the present Embodiment, the image bearing member is the intermediary transfer member which conveys the toner image transferred from another image bearing member (photosensitive drum) 61 to the transfer portion T2, and the opposing member is the intermediary transfer member.

In addition, in the present Embodiment, the intermediary transfer member is constituted by the endless belt (intermediary transfer belt) 41, and the opposing member is the roller (auxiliary roller) 48 which stretches the belt 41. In addition, in the present Embodiment, the charge eliminating cloth 60 is electrically floated. In particular, in the present Embodiment, the supporting surface 49b is constituted by the conductor. In addition, it is preferable that the length of the charge eliminating cloth 60 in the conveyance direction of the recording material S be 3 mm or more, and it is preferable that the shortest distance between the recording material S being conveyed by both the conveyance portion F and the transfer portion T2 and the charge eliminating cloth 60 be 6 mm or less. In addition, it is preferable that the length of the charge eliminating cloth 60 in the direction substantially perpendicular to the conveyance direction of the recording material S be longer than the width of the recording material S, of which the width in the direction substantially perpendicular to the conveyance direction is maximum, of the recording material S to be conveyed from the feeding portion 31 to the transfer portion T2. In addition, in the present Embodiment, the surface of the recording material S being conveyed by both the conveyance portion F and the transfer portion T2 in the position where the normal line of the supporting surface 49b crosses itself is substantially parallel to the direction of gravity. In addition, it is more preferable that the angle formed by the normal direction of the supporting surface 49b and the direction of gravity be 70 degrees or more and 80 degrees or less.

As described above, according to the present Embodiment, by disposing the charge eliminating cloth 60 for eliminating the charge of the sheet S between the registration roller pair 4 and the secondary transfer portion T2, it becomes possible to eliminate the charge of the sheet S before the sheet S is conveyed to the secondary transfer portion T2. By this, it becomes possible to suppress the occurrence of the image defect due to the abnormal electric discharge in the secondary transfer portion T2. In addition, in the present Embodiment, the charge eliminating cloth 60 is disposed so as to face downward, and the potential of the charge eliminating cloth 60 is made higher than the potential of the opposing member via the sheet S.

By this, while suppressing that the paper dust falling from above the charge eliminating cloth 60 is accumulated on the charge eliminating cloth 60, by causing the paper dust to go away from the charge eliminating cloth 60 by the action of the electric field which acts between the charge eliminating cloth 60 and the opposing member, it is suppressed that the paper dust contacts the charge eliminating cloth 60. As a result, it becomes possible to suppress the contamination in the charge eliminating cloth 60 due to the paper dust. Incidentally, as described above, of disposing the charge eliminating cloth 60 so as to face downward and making the potential of the charge eliminating cloth 60 higher than the potential of the opposing member via the sheet S, at least disposing the charge eliminating cloth 60 so as to face downward may be employed. By this, it becomes possible to suppress that the paper dust falling from above the charge eliminating cloth 60 is accumulated on the charge eliminating cloth 60, and suppress the contamination in the charge eliminating cloth 60 due to the paper dust. In this manner, according to the present Embodiment, it becomes possible to suppress that the member, which eliminates the charge of the recording material being conveyed to the transfer portion, is contaminated by the paper dust, and perform the charge elimination of the recording material appropriately.

### Embodiment 2

Next, another Embodiment of the present invention will be described. Basic configurations and operations of an image forming apparatus in the present Embodiment are the same as those of the image forming apparatus in the Embodiment 1. Therefore, in the image forming apparatus in the present Embodiment, to those elements having functions or configurations that are the same as or corresponding to those of the image forming apparatus in the Embodiment 1, the same reference numerals as in the Embodiment 1 will be attached, and detailed description thereof will be omitted.

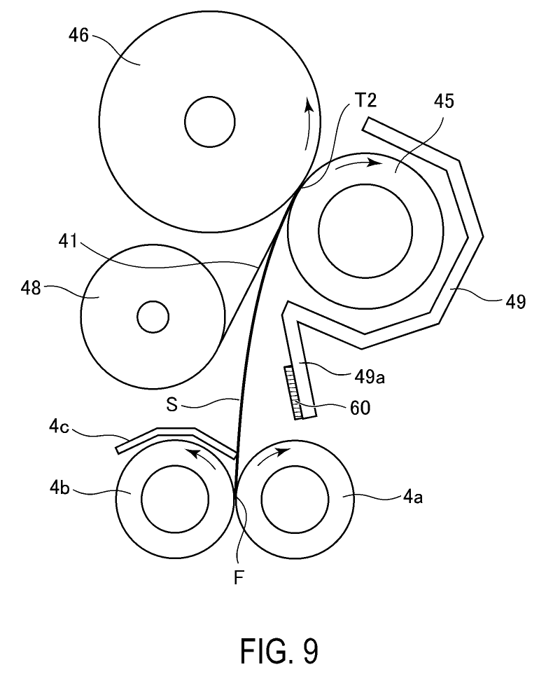

FIG. 9 is a schematic cross-sectional view illustrating a configuration around a registration roller pair 4 and a secondary transfer portion T2 in the present Embodiment (illustrating a cross section approximately perpendicular to respective rotational axis directions of the registration roller pair 4 and the secondary transfer roller 45.).

As shown in FIG. 9, in a conveyance path of a sheet S, a charge eliminating cloth 60 is disposed at the same position as in the Embodiment 1. However, in the present Embodiment, a supporting surface 49b of the charge eliminating cloth 60 in a pre secondary transfer guide 49a is composed of an insulator. In the present Embodiment, a material of the supporting surface 49b is PC + ABS, which is common with the pre secondary transfer guide 49a. In other words, in the present Embodiment, the pre secondary transfer guide 49a is not provided with the sheet metal, which is provided as the supporting surface 49b in the Embodiment 1, and the charge eliminating cloth 60 is directly attached to the pre secondary transfer guide 49a. In the present Embodiment, the charge eliminating cloth 60 is fixed onto the pre secondary transfer guide 49 (supporting surface 49b) by a double-sided tape.

In addition, in the present Embodiment, a distance between the sheet S and the charge eliminating cloth 60 is set to 6.0 mm, similarly to the Embodiment 1. In addition, in the present Embodiment, an angle D of the supporting surface 49b of the charge eliminating cloth 60 is set to 75 degrees, similarly to the Embodiment 1.

In this manner, even with the configuration in which the charge eliminating cloth 60 is disposed on the insulator, when an Experiment similar to the Experiment C and the Experiment D described above was conducted, frequency of occurrence of image defect after continuous sheet passing of one hundred thousand sheets was zero sheet per one hundred sheets. In addition, even with the configuration of the present Embodiment, during sheet passing (during sheet passing of twenty sheets), a potential of the charge eliminating cloth 60 rose. In the present Embodiment, whereas a potential of the intermediary transfer belt 41 (auxiliary roller 48) as an opposing member of the charge eliminating cloth 60 during sheet passing was +200 V, the potential of the charge eliminating cloth 60 during sheet passing rose up to +600 V. Since the potential of the charge eliminating cloth 60 becomes higher than the potential of the opposing member, it becomes possible to cause the paper dust generated before the sheet S enters the secondary transfer portion T2 to go away from the charge eliminating cloth 60, and maintain the charge eliminating effect.

As described above, according to the present Embodiment as well, similarly to the Embodiment 1, it becomes possible to suppress that the member, which eliminates the charge of the recording material being conveyed to the transfer portion, is contaminated by the paper dust, and to perform the charge elimination of the recording material appropriately.

### Others

As described above, the present invention has been described according to the specific Embodiments, however, the present invention is not limited to the above Embodiments.

In the Embodiments described above, the charge eliminating cloth is disposed on the surface side on the opposite side to the surface of the recording material, onto which the toner image is to be transferred in the transfer portion immediately thereafter, however, it may be configured to be disposed on a side of the surface of the recording material, onto which the toner image is to be transferred in the transfer portion immediately thereafter.

In the Embodiments described above, the secondary transfer voltage, which has the opposite polarity to the normal charging polarity of the toner, is applied to the secondary transfer member, which forms the secondary transfer portion by being in contact with the outer peripheral surface of the intermediary transfer belt, and the roller which contacts the inner peripheral surface of the intermediary transfer belt is electrically grounded. In contrast to this, it may be configured that the secondary transfer voltage, which has the same polarity as the normal charging polarity of the toner, is applied to the roller which contacts the inner peripheral surface of the intermediary transfer belt, and the secondary transfer member, which forms the secondary transfer portion by being in contact with the outer peripheral surface of the intermediary transfer belt, is electrically grounded.

In addition, in the Embodiments described above, the present invention is applied to the color image forming apparatus, and the charge eliminating cloth is provided to the conveyance path of the recording material to be conveyed to the secondary transfer portion. However, the present invention is not limited thereto, but as the image forming apparatus, the present invention may also be applied to a monochrome image forming apparatus which is provided with only one image forming portion provided with the photosensitive drum, etc. In this case, a charge eliminating cloth is provided to a conveyance path of a recording material to be conveyed to a transfer portion, which transfers a toner image from an image bearing member such as a photosensitive drum to the recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-027417 filed on Feb. 21, 2025, which is hereby incorporated by reference herein in its entirety.

What is claimed is:

1. An image forming apparatus comprising:
an image bearing member configured to bear a toner image;
a transfer member configured to form a transfer portion to transfer the toner image from the image bearing member to a recording material by being in contact with the image bearing member and to convey the recording material in the transfer portion;
a feeding portion on which the recording material is placed;
a feeding member configured to feed the recording material placed on the feeding portion from the feeding portion toward the transfer portion;
a conveyance member configured to form a conveyance portion to convey the recording material fed from the feeding portion and to upwardly convey the recording material toward the transfer portion;
a sheet-like charge eliminating cloth configured to eliminate charge of the recording material at a position downstream of the conveyance portion and upstream of the transfer portion in a conveyance direction of the recording material, the charge eliminating cloth being disposed so as to oppose a surface of the recording material being conveyed by both the conveyance portion and the transfer portion in a non-contact manner; and
a supporting member provided with a supporting surface to support the charge eliminating cloth,
wherein an angle formed by a normal line of the supporting surface and a direction of gravity is 45 degrees or more and less than 90 degrees.

2. The image forming apparatus according to claim 1, further comprising an opposing member configured to oppose the charge eliminating cloth via the recording material being conveyed by both the conveyance portion and the transfer portion,
wherein the charge eliminating cloth is charged so that a potential of the charge eliminating cloth becomes a high potential on a positive polarity side to a potential of the opposing member by eliminating the charge of the recording material being fed from the feeding portion to the transfer portion with the charge eliminating cloth.

3. The image forming apparatus according to claim 2, wherein the image bearing member is an intermediary transfer member configured to convey the toner image transferred from another image bearing member to the transfer portion, and
wherein the opposing member is the intermediary transfer member.

4. The image forming apparatus according to claim 3, wherein the intermediary transfer member is constituted by an endless belt, and
wherein the opposing member is a roller configured to stretch the belt.

5. The image forming apparatus according to claim 1, wherein the charge eliminating cloth is electrically floated.

6. The image forming apparatus according to claim 5, wherein the supporting surface is constituted by a conductor.

7. The image forming apparatus according to claim 5, wherein the supporting surface is constituted by an insulator.

8. The image forming apparatus according to claim 1, wherein a length of the charge eliminating cloth in the conveyance direction of the recording material is 3mm or more, and
wherein a shortest distance between the recording material being conveyed by both the conveyance portion and the transfer portion and the charge eliminating cloth is 6mm or less.

9. The image forming apparatus according to claim 1, wherein a length of the charge eliminating cloth in a direction substantially perpendicular to the conveyance direction of the recording material is longer than a width of the recording material of which a width in the direction substantially perpendicular to the conveyance direction is maximum, of the recording material to be conveyed from the feeding portion to the transfer portion.

10. The image forming apparatus according to claim 1, wherein the surface of the recording material being conveyed by both the conveyance portion and the transfer portion in a position where the normal line of the supporting surface crosses itself is substantially parallel to the direction of gravity.

11. The image forming apparatus according to claim 1, wherein an angle formed by a normal direction of the supporting surface and the direction of gravity is 70 degrees or more and 80 degrees or less.
